(19) United States
(12) Patent Application Publication
(10) Pub. No.: US 2024/0378440 A1
(43) Pub. Date: Nov. 14, 2024

(54) SYMBOLIC KNOWLEDGE IN DEEP MACHINE LEARNING

(71) Applicant: NEC Laboratories America, Inc., Princeton, NJ (US)

(72) Inventors: Alexandru Niculescu-Mizil, Plainsboro, NJ (US); Konstantinos Dafnis, Highland Park, NJ (US)

(21) Appl. No.: 18/656,894

(22) Filed: May 7, 2024

Related U.S. Application Data
(60) Provisional application No. 63/500,677, filed on May 8, 2023.

(51) Int. Cl. G06N 3/08

(52) U.S. Cl. CPC G06N 3/08

(57) ABSTRACT

Methods and systems for deep learning include encoding input data, using a data encoder machine learning model, to generate an embedded representation of the input data. A correction is added to the input data with a rule encoder machine learning model to generate a corrected representation. The corrected representation is decoded using a data decoder machine learning model to generate a prediction. Parameters of the rule encoder machine learning model are updated using a loss function that encodes symbolic information relating to the prediction.

### RELATED APPLICATION INFORMATION

This application claims priority to U.S. Patent Application No. 63/500,677, filed on May 8, 2023, incorporated herein by reference in its entirety.

### BACKGROUND

### Technical Field

The present invention relates to and more particularly the use of symbolic constrains in deep learning systems.

### Description of the Related Art

While deep learning techniques are very effective at processing certain types of data, such as text and visual inputs, symbolic knowledge is less readily accessible to them. For example, whereas machine learning models may be designed to extract information from large amounts of input/output pairs,

### SUMMARY

A method for deep learning includes encoding input data, using a data encoder machine learning model, to generate an embedded representation of the input data. A correction is added to the input data with a rule encoder machine learning model to generate a corrected representation. The corrected representation is decoded using a data decoder machine learning model to generate a prediction. Parameters of the rule encoder machine learning model are updated using a loss function that encodes symbolic information relating to the prediction.

A method for medical decision making includes encoding input data, using a data encoder machine learning model, to generate an embedded representation of the input data. A correction is added to the input data with a rule encoder machine learning model to generate a corrected representation that incorporates symbolic information that imposes a constraint. The corrected representation is decoded using a data decoder machine learning model to generate a prediction. A treatment action is performed responsive to the prediction.

A system for deep learning includes a hardware processor and a memory that stores a computer program. When executed by the hardware processor, the computer program causes the hardware processor to encode input data, using a data encoder machine learning model, to generate an embedded representation of the input data, to add a correction to the input data with a rule encoder machine learning model to generate a corrected representation, to decode the corrected representation using a data decoder machine learning model to generate a prediction, and to update parameters of the rule encoder machine learning model using a loss function that encodes symbolic information relating to the prediction.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a deep learning model that includes a rule encoder to correct an embedded representation of data using symbolic information, in accordance with an embodiment of the present invention;

FIG. 2 is a block/flow diagram of a method of training and using a deep learning model that employs symbolic information, in accordance with an embodiment of the present invention;

FIG. 3 is a block diagram of a healthcare facility that employs a deep learning model with symbolic rules for medical decision making, in accordance with an embodiment of the present invention;

FIG. 4 is a block diagram of a computing device that can perform deep learning with symbolic information encoding, in accordance with an embodiment of the present invention;

FIG. 5 is a diagram of an exemplary neural network architecture that can be used to implement the rule encoder, in accordance with an embodiment of the present invention; and

FIG. 6 is a diagram of an exemplary deep neural network architecture that can be sued to implement the rule encoder, in accordance with an embodiment of the present invention.

### DETAILED DESCRIPTION OF PREFERRED EMBODIMENTS

Symbolic knowledge may be incorporated in a in a machine learning system by correcting internal encodings of a deep learning model, such that the final output reflects the relevant symbolic knowledge. For example, in a machine learning system that employs an autoencoder structure, an encoder may be used to create an embedded representation of an input, while a decoder translates the embedded representation into a target domain. A rule encoder may be used to create an embedded representation of the symbolic knowledge that is combined with the embedded representation of the input. The decoder then works on the combination of the embedded representation of the input and the embedded representation of the symbolic knowledge. Approaching the problem in this fashion preserves implicit knowledge learned by the deep learning system.

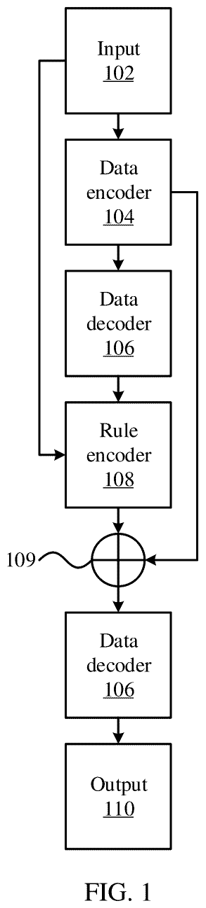

Referring now to FIG. 1, a diagram of a deep neural network model with symbolic knowledge is shown. An input 102 is provided that may include data as well as a symbolic rule that is to be used. The data may be any appropriate type of information that is in a format to be processed by the model, such as time series information, visual information, textual information, or any other appropriate data type.

A data encoder 104 takes raw data from the input 102 and transforms it into an internal representation z_{d}. A data decoder 106 takes the internal representation z_{d} and transforms it into a prediction \tilde{y}. The data encoder 104 and the data decoder 106 may be trained using a set of training data as the input 102 and backpropagation, using an appropriate task loss to govern how the weights of the data encoder 104 and the data decoder 106 are adjusted. The task loss may be tailored to a particular application for the model to capture differences between the prediction generated by the decoder 106 and a ground truth included in the training data.

A rule encoder 108 is used to create a representation of symbolic knowledge, and may be implemented by any appropriate machine learning model, such as a multi-layer perceptron, a convolutional neural network, or a transformer model. The rule encoder 108 takes a concatenation of the original data from the input 102, or some transformation thereof, with the output predicted by the data decoder 106 and generates a correction zᵣ. The correction is then combined with the internal encoding generated by the data decoder 106, for example by adding 109 the two as vectors as a weighted sum, to generate a corrected internal representation z. The weights in the weighted sum are learned during training of the model.

The data decoder 106 may be used again, this time taking the corrected internal representation z as input, to generate a final prediction ŷ as output 110. It is specifically contemplated that the same data decoder 106 (e.g., using the same weight parameters) may be used in this instance as was used to generate the prediction \tilde{y}.

The rule encoder 108 may be trained separately from the data encoder 104 and the data decoder 106. Training of the rule encoder 108 may also be performed via backpropagation, using a loss function [symbol] ᵣᵤₗₑ that has a first part to quantify how far its output is from satisfying the symbolic knowledge and a second part to encourage the corrected prediction ŷ to be similar to the original prediction \tilde{y}. The form of [symbol] ᵣᵤₗₑ will depend on the particulars of the symbolic knowledge that is to be encoded. [symbol] ᵣᵤₗₑ should be differentiable and should have a value of zero when the rule is satisfied. For example, if the rule is D=VT, where D is distance, V is velocity, and T is time, then an example loss function might be [symbol] ᵣᵤₗₑ=∥D−VT ∥².

The training of the rule encoder 108 may be trained at the same time as the data encoder 104 and the data decoder 106, or may be trained to correct an existing pre-trained deep learning system. The rule encoder 108 may be trained on the same labeled training data used to train the data encoder 104 and the data decoder 106 or may be used on separate data.

For example, the deep learning model may be trained to predict the next physical state of a chaotic system, such as a double pendulum. The double pendulum is a physical system where a second pendulum hangs from a first pendulum. The motion of a double pendulum is chaotic, showing high sensitivity to initial conditions. Thus, given the state of the system with arbitrary precision, it can be difficult to predict how that system will behave in the future.

In this context, the training data may be made up of trajectories of the double pendulum that have been recorded in the past. The deep learning system may thereby be trained to make predictions for future states of the system. However, the sensitivity of the system to initial conditions makes this prediction limited in its utility.

The symbolic knowledge in the context of the double pendulum example may represent the formulae that govern the evolution of the double pendulum system through time. One specific example may be to impose the laws of thermodynamics, such that the energy of the of the system at a time t will be equal to or less than the energy of the system at a time t+1. For example, the rule may be implemented as the first part of the loss function as:

$${ℒ}_{rule} ( x , \hat{y} ) = Re LU ( E ( \hat{y} ) - E ( x ) )$$

where x is a present state of the system, ŷ is a corrected predicted future state of the system, E(⋅) is the energy of a given state, and ReLU(⋅) is a rectified linear unit function that may return zero for negative inputs and that may return the input unchanged for positive inputs. Thus, if the predicted state has a greater energy than the current state, the loss function will return a positive result. The second part of the loss function may be implemented as |ŷ−\tilde{y}|₁

This example rule is provided to illustrate how symbolic information for a given system can be translated into a form that can be understood by the deep learning system. It should be understood that any given symbolic information will need to be encoded as its own rule.

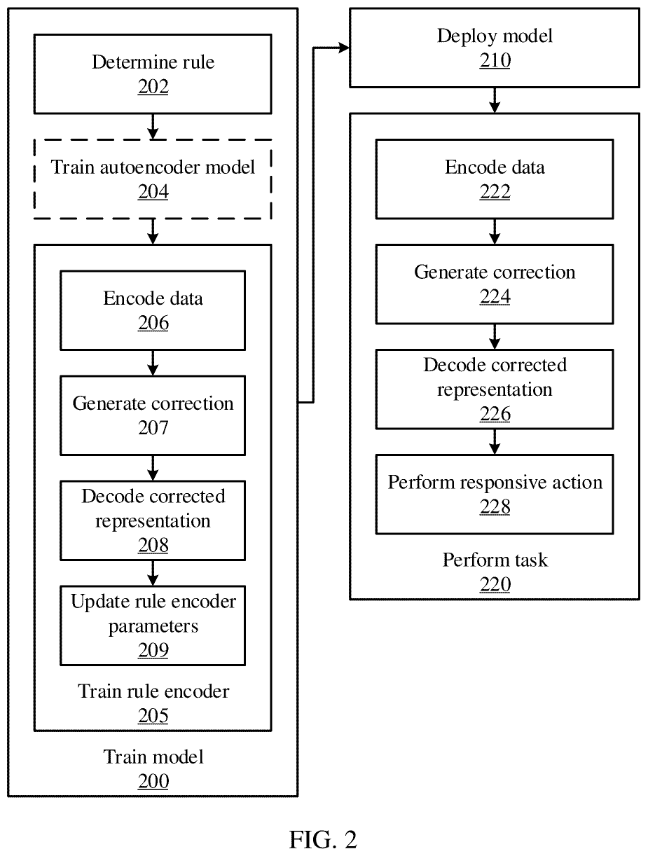

Referring now to FIG. 2, a method for training and using a model that includes representations of symbolic information is shown. Block 200 trains the model using a training dataset to perform a given task. Block 210 then deploys the model for use, for example transmitting the model to, or installing the model at, a healthcare facility. Block 220 executes the task, using new input data, with the benefit of the symbolic information.

The training 200 of the model in particular determines a rule in block 202 that captures the symbolic information. For physical systems, this symbolic information may include constraints on the behavior of the system, such as conservation laws. In a healthcare setting, such information may relate to characteristics of particular diseases. For example, the rule may encode information relating to symptoms of a disease.

Training the autoencoder model, for example including the data encoder 104 and the data decoder 106, may optionally be performed by block 204. In some cases, this model may be a pre-trained model that is already suited for performing the task at hand. In either case, the data encoder 104 and the data decoder 106 may be jointly trained as an autoencoder such that the data decoder 106 replicates the input data. Block 205 trains the rule encoder 108 as described above, using a loss function that includes a term to capture the symbolic information.

During training of the rule encoder 205, an example from a training dataset is encoded in block 206, for example generating an embedded representation of the training example. Block 207 generates a correction to the embedded representation using the trained rule encoder 108, which is added to the embedded representation using a weighted sum to generate a corrected representation. Block 208 then decodes the corrected representation to form a prediction. Based on this prediction, and a comparison to a ground truth prediction from the training dataset, block 209 updates weights of the rule encoder 108.

During performance of the task 220, the rule encoder 108 continues to be used to apply corrections to the embedded representation from the data encoder 104. The parameters of the rule encoder 108 are adapted during training 200 to adjust the internal representation in a manner that improves compliance with the rule established in accordance with the symbolic information.

During operation 220, new data is encoded in block 222, for example generating an embedded representation of the present state of a given system or a patient's health condition. Block 224 generates a correction to the embedded representation using the trained rule encoder 108, which is added to the embedded representation using a weighted sum to generate a corrected representation. Block 226 then decodes the corrected representation to form a prediction. Based on this prediction, block 228 performs a responsive action.

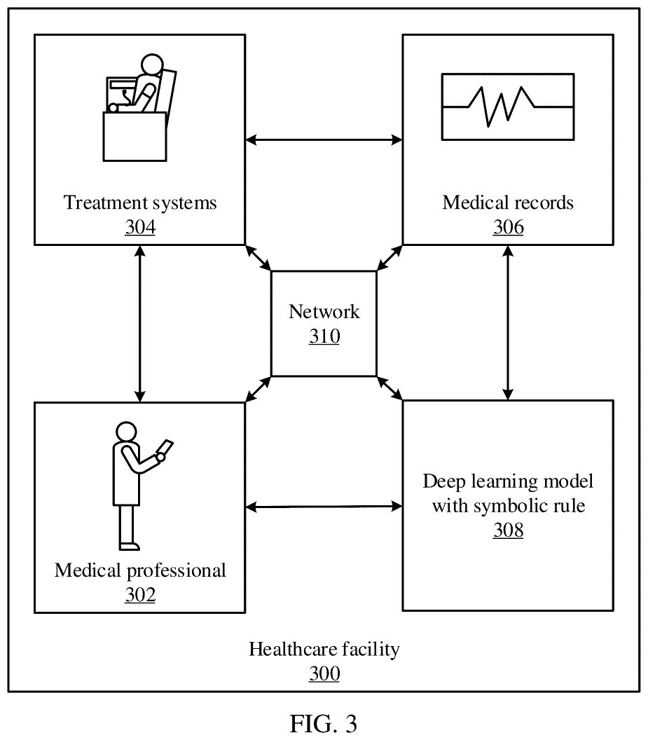

Referring now to FIG. 3, a diagram of information extraction is shown in the context of a healthcare facility 300. A deep learning model with symbolic rules 308 may be used to aid in medical decision making. For example, the human body is a complicated system that can behave in unpredictable ways, but nonetheless follows certain principles that can be encoded as symbolic information. For example, blood pressure and velocity are measurable quantities that obey physical laws due to the fluid dynamics of blood. These quantities relate to a variety of the body's functions, and can be used to predict negative health outcomes. The deep learning model with symbolic rules 308 may take time series information relating to such biometric information and may generate predictions on the patient's health condition using the symbolic information added by rule encoder 108.

The healthcare facility may include one or more medical professionals 302 who review information extracted from a patient's medical records 306 to determine their healthcare and treatment needs. These medical records 306 may include self-reported information from the patient, test results, and notes by healthcare personnel made to the patient's file. For example, the medical records 306 may include measurements of the patient's blood pressure and other relevant time series, which may be used as input to the deep learning model with symbolic rules 308. Treatment systems 304 may furthermore monitor patient status to generate medical records 306 and may be designed to automatically administer and adjust treatments as needed.

Based on predictions generated by the deep learning model with symbolic rules 308, the medical professionals 302 may then make medical decisions about patient healthcare suited to the patient's needs. For example, the medical professionals 302 may make a diagnosis of the patient's health condition and may prescribe particular medications, surgeries, and/or therapies.

The different elements of the healthcare facility 300 may communicate with one another via a network 310, for example using any appropriate wired or wireless communications protocol and medium. Thus the deep learning model with symbolic rules 308 may receive inputs from medical professionals 302, from treatment systems 304, and from medical records 306, and may update the medical records 306 with the its predictions. The model 308 further may coordinate with treatment systems 304 in some cases to automatically administer or alter a treatment. For example, if the model 308 predicts a dangerous health condition after a new treatment has begun, the treatment systems 304 may automatically alter or halt the administration of a treatment.

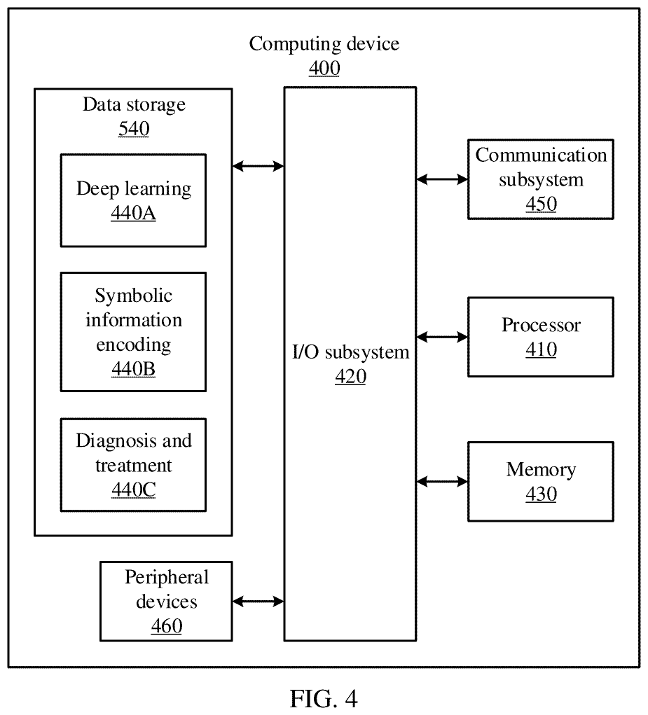

Referring now to FIG. 4, an exemplary computing device 400 is shown, in accordance with an embodiment of the present invention. The computing device 400 is configured to perform visual question answering.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for deep learning, 440B for symbolic information encoding, and/or 440C for performing diagnosis and treatment. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

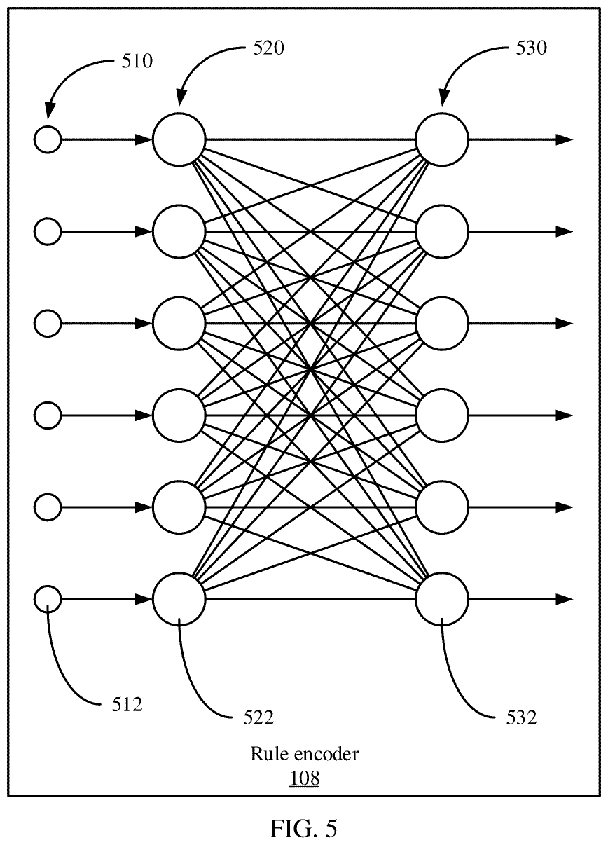

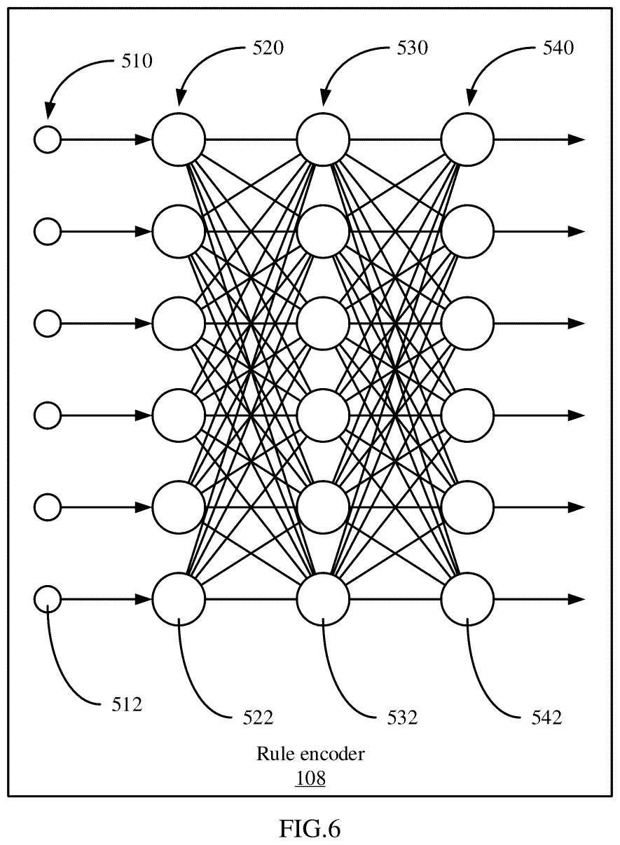

Referring now to FIGS. 5 and 6, exemplary neural network architectures are shown, which may be used to implement parts of the present machine learning models, such as the rule encoder 108. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for deep learning, comprising:
encoding input data, using a data encoder machine learning model, to generate an embedded representation of the input data;
adding a correction to the input data with a rule encoder machine learning model to generate a corrected representation;
decoding the corrected representation using a data decoder machine learning model to generate a prediction; and
updating parameters of the rule encoder machine learning model using a loss function that encodes symbolic information relating to the prediction.

2. The method of claim 1, wherein the loss function includes a term to keep the prediction close to a prediction generated by the data decoder machine learning model from the embedded representation without the correction.

3. The method of claim 1, wherein adding the correction to the input data is performed as a weighted sum.

4. The method of claim 1, wherein adding the correction to the input data includes generating the correction using a concatenation of the input data with a prediction generated by the data decoder machine learning model from the embedded representation.

5. The method of claim 1, wherein the input data relates to a patient in a healthcare setting and the prediction indicates a health condition of the patient.

6. The method of claim 1, wherein the symbolic information imposes a constraint on the prediction according to physical properties of an underlying system.

7. The method of claim 1, wherein the data encoder machine learning model and the data decoder machine learning model are implemented as a jointly trained autoencoder neural network.

8. A computer-implemented method for medical decision making, comprising:
encoding input data, using a data encoder machine learning model, to generate an embedded representation of the input data;
adding a correction to the input data with a rule encoder machine learning model to generate a corrected representation that incorporates symbolic information that imposes a constraint;
decoding the corrected representation using a data decoder machine learning model to generate a prediction; and
performing a treatment action responsive to the prediction.

9. The method of claim 8, wherein adding the correction to the input data is performed as a weighted sum.

10. The method of claim 8, wherein adding the correction to the input data includes generating the correction using a concatenation of the input data with a prediction generated by the data decoder machine learning model from the embedded representation.

11. The method of claim 8, wherein the input data relates to a patient in a healthcare setting and the prediction indicates a health condition of the patient.

12. The method of claim 11, wherein the treatment action includes altering or halting a treatment responsive to the prediction.

13. The method of claim 8, wherein the data encoder machine learning model and the data decoder machine learning model are implemented as a jointly trained autoencoder neural network.

14. A system for deep learning, comprising:
a hardware processor; and
a memory that stores a computer program which, when executed by the hardware processor, causes the hardware processor to:
encode input data, using a data encoder machine learning model, to generate an embedded representation of the input data;
add a correction to the input data with a rule encoder machine learning model to generate a corrected representation;
decode the corrected representation using a data decoder machine learning model to generate a prediction; and
update parameters of the rule encoder machine learning model using a loss function that encodes symbolic information relating to the prediction.

15. The system of claim 14, wherein the loss function includes a term to keep the prediction close to a prediction generated by the data decoder machine learning model from the embedded representation without the correction.

16. The system of claim 14, wherein the computer program further causes the hardware processor to add the correction to the input data as a weighted sum.

17. The system of claim 14, wherein the computer program further causes the hardware processor to generate the correction using a concatenation of the input data with a prediction generated by the data decoder machine learning model from the embedded representation.

18. The system of claim 14, wherein the input data relates to a patient in a healthcare setting and the prediction indicates a health condition of the patient.

19. The system of claim 14, wherein the symbolic information imposes a constraint on the prediction according to physical properties of an underlying system.

20. The system of claim 14, wherein the data encoder machine learning model and the data decoder machine learning model are implemented as a jointly trained autoencoder neural network.
